(19) United States
(12) Patent Application Publication
(10) Pub. No.: US 2013/0168005 A1
(43) Pub. Date: Jul. 4, 2013

(54) DEVICES, SYSTEMS, METHODS, AND COMPUTER-READABLE MEDIA FOR FORMING A FIBER PANEL

(71) Applicant: Enviro Board Corporation, Camden, NJ (US)

(72) Inventor: Scott J. Horowitz, Deer Mountain, UT (US)

(73) Assignee: Enviro Board Corporation, Camden, NJ (US)

(21) Appl. No.: 13/729,358

(22) Filed: Dec. 28, 2012

Related U.S. Application Data
(60) Provisional application No. 61/581,568, filed on Dec. 29, 2011.

(51) Int. Cl. B27N 3/04; B27N 3/18; B27N 3/20

(52) U.S. Cl. CPC B27N 3/04; B27N 3/203; B27N 3/183
USPC 156/64; 100/95; 100/98 R; 100/326; 100/319; 83/648; 83/370; 156/531; 156/361; 156/378

(57) ABSTRACT

Exemplary embodiments are directed to systems, methods, devices, and computer-readable media for forming a fiber panel. A system may include a feed section for unrolling a round bale of material. The system may further include a compression section for receiving material from the unrolled bale of material. The compression section may include a press configured to apply a force to the material and a plurality of pistons to apply another force to the material. Additionally, the system may include an adjustable cutting section including a saw and configured to cut the material to form a panel having a desired length.

### BACKGROUND

1. Field

The present invention relates generally to fiber panels. More specifically, the present invention relates to systems, devices, methods, and computer-readable medium for forming fiber panels.

2. Background

The use of fiber material in the manufacture of architectural material is known. As one example, fiber material may be compressed into panels which can then be used for structural panels in building activities.

As will be appreciated by a person having ordinary skill in the art, conventional devices for forming fiber panels have may include a debater for cutting a fiber bale and/or a shredder for shredding the fiber material. Further, a conventional device may include a compression assembly having a ram for compressing the fiber material into a longitudinal panel member.

These conventional devices have exhibited several deficiencies. As one example, a density of the fiber panels, both within and between panels, may be inconsistent. The inconsistency may result from a greater or lesser amount of material being compressed by a reciprocating ram and then continuing down the curing table. The longer the length of compressed material for the panel members became, the more difficulty the ram had in moving the panel. This resulted in panels having lesser densities at the forward end of the panel and greater densities at the rearward end of the panel closer to the reciprocating ram.

### BRIEF DESCRIPTION OF THE DRAWINGS

FIG. 1 illustrates a system for forming a fiber panel, according to an exemplary embodiment of the present invention.

FIG. 2 is a top-down view of the system of FIG. 1.

FIG. 3 is a view of the system of FIG. 1 taken along line 3 of FIG. 1.

FIG. 4 is a view of the system of FIG. 1 taken along line 4 of FIG. 1.

FIG. 5 illustrates a material receiving section of the system of FIG. 1, in accordance with an exemplary embodiment of the present invention.

FIG. 6 is a top-down view of the material receiving section of FIG. 5.

FIG. 7 is a view of the material receiving section of FIG. 5 taken along line 7 of FIG. 5.

FIG. 8 is a view of the material receiving section of FIG. 5 taken along line 8 of FIG. 5.

FIG. 9 illustrates a feed section of the system of FIG. 1, according to an exemplary embodiment of the present invention.

FIG. 10 is a top-down view of the feed section of FIG. 9.

FIG. 11 is a view of the feed section of FIG. 9 taken along line 11 of FIG. 9.

FIG. 12 is a view of the feed section of FIG. 9 taken along line 12 of FIG. 9.

FIG. 13 illustrates a press section of the system of FIG. 1, in accordance with an exemplary embodiment of the present invention.

FIG. 14 is a top-down view of the press section of FIG. 13.

FIG. 15 is a view of the press section of FIG. 13 taken along line 15 of FIG. 13.

FIG. 16 is a view of the press section of FIG. 13 taken along line 16 of FIG. 13.

FIG. 17 illustrates primary platens of the system of FIG. 1, according to an exemplary embodiment of the present invention.

FIG. 18 is a top-down view of the primary platens of FIG. 17.

FIG. 19 is a view of the primary platens of FIG. 17 taken along line 19 of FIG. 17.

FIG. 20 is a view of the primary platens of FIG. 17 taken along line 20 of FIG. 17.

FIG. 21 illustrates an adhesive applicator, secondary platens, and a tension roller of the system of FIG. 1, in accordance with an exemplary embodiment of the present invention.

FIG. 22 is a top-down view of the adhesive applicator, the secondary platens, and the tension roller of FIG. 21.

FIG. 23 is a view of the adhesive applicator, the secondary platens, and the tension roller of FIG. 21 taken along line 23 of FIG. 21.

FIG. 24 is a view of the adhesive applicator, the secondary platens, and the tension roller of FIG. 21 taken along line 24 of FIG. 21.

FIG. 25 illustrates a cutting section of the system of FIG. 1, in accordance with an exemplary embodiment of the present invention.

FIG. 26 is a top-down view of the cutting section of FIG. 25.

FIG. 27 is a view of the cutting section of FIG. 25 taken along line 27 of FIG. 25.

FIG. 28 is a view of the cutting section of FIG. 25 taken along line 28 of FIG. 25.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Exemplary embodiments described herein relate to devices, systems, methods, and computer-readable media for forming fiber panels. As one example, a system may include a feed section for unrolling a round bale of material. The system may further include a compression section for receiving material from the unrolled bale of material. The compression section may include a press configured to apply a force to the material and a plurality of pistons to apply another force to the material. Additionally, the system may include an adjustable cutting section including a saw and configured to cut the material to form a panel having a desired length. As another example, a system may include a feed section for unrolling a cylindrical bale of material. Further, the system may include a two-stage compression section configured to cut and apply a compression force to material of the unrolled bale of material in at least two directions to form compressed material. Moreover, the system may include a controller configured for adjusting at least the feed section to control a density of the compressed material.

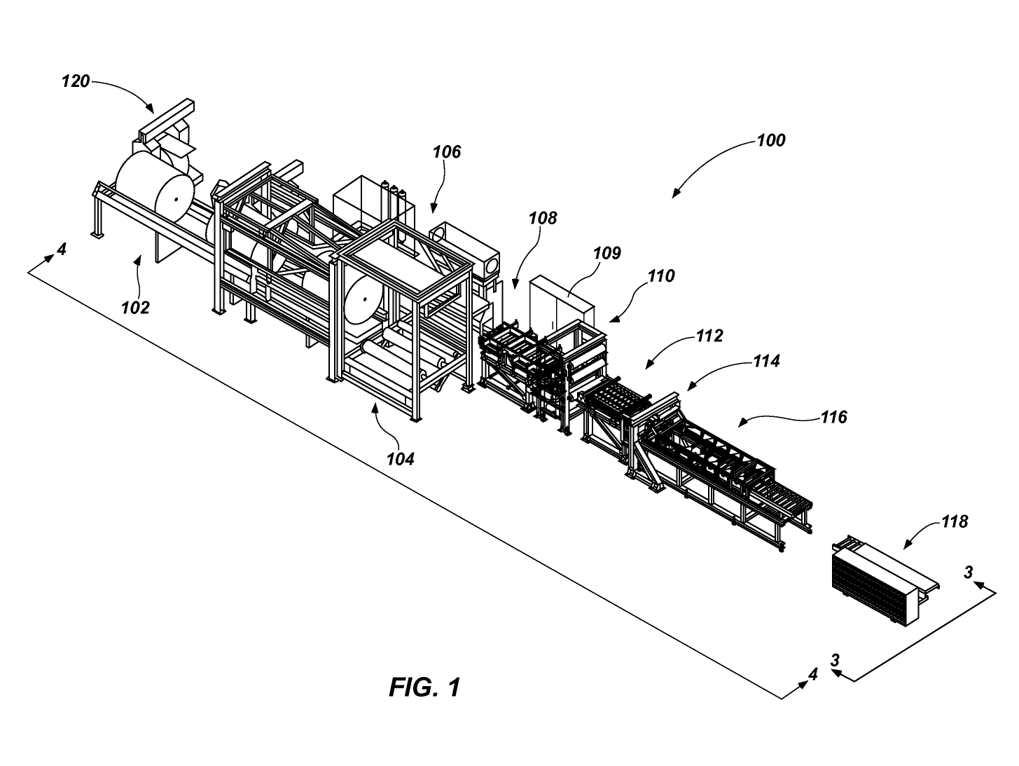

FIG. 1 illustrates a system 100, according to an exemplary embodiment of the present invention. System 100 may be configured for forming a fiber panel. More specifically, system 100 is configured to receive a fiber material (e.g., straw) and compress the fiber material into a panel having a desired thickness, height, width, and density. System 100 includes a plurality of sections or areas of particular interest, namely a material receiving section 102, which may also be referred to as an “infeed section,” a feed section 104, a compression section 106, primary platens 108, adhesive applicator 110, secondary platens 112, tension roller 112, and a cutting section 116. Resulting panels 118 are also illustrated in FIG. 1. Several of these sections will be described in greater detail below.

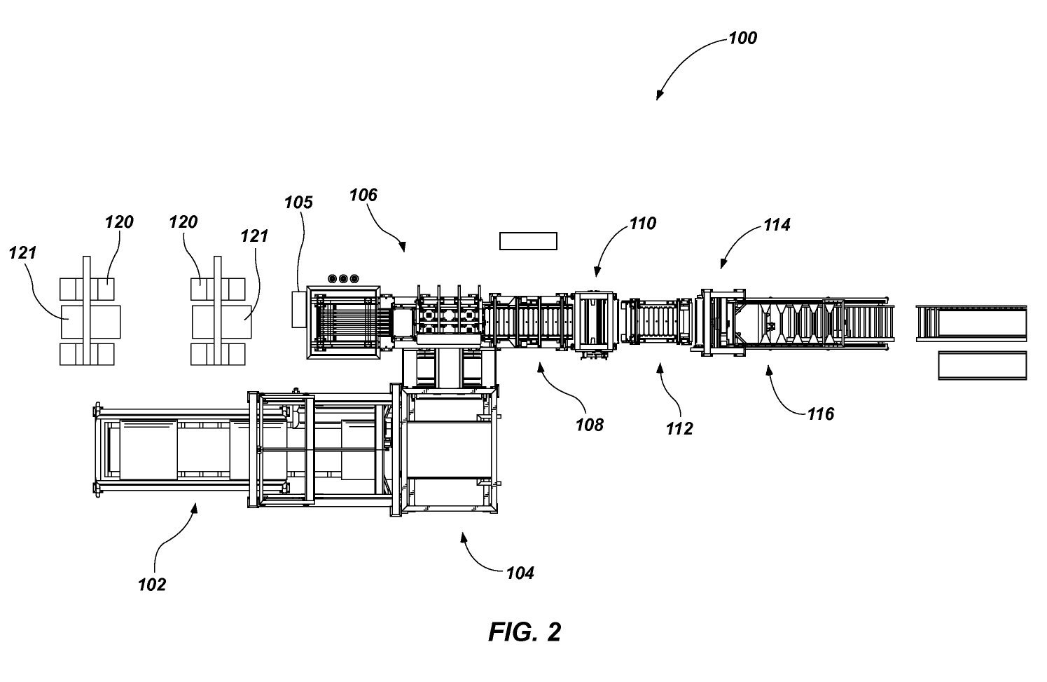

FIG. 2 is a top-down view of system 100 of FIG. 1 including material receiving section 102, feed section 104, compression section 106, primary platens 108, adhesive applicator 110, secondary platens 112, tension roller 114, and cutting section 116.

Further, FIG. 2 illustrates paper rollers 120, which may be positioned proximate system 100 and may be configured to hold respective paper rolls 121. System 100 may include a plurality of festoons (not shown) (i.e., one festoon associated with each paper roller 120) positioned between paper rollers 120 and compression section 106. Each festoon may be configured to take up slack in paper from a respective paper roller 120 during repeated feeding between starting and stopping during each material compression stage, as described more fully below. In addition to a festoon, system 100 may include one or more sensors positioned proximate each festoon and configured to ensure that paper is pulled out of a respective paper roller 120 as paper is fed into adhesive applicator 110, and that an appropriate amount (e.g., length, etc.) of paper is fed back into the festoon as the feed of paper into adhesive applicator 110 stops during each stage of compression section 106. Utilizing a festoon may minimize, and possibly prevent, the ripping of paper, which is common in prior art systems due to repeated feeding and stopping required as fiber material is compressed.

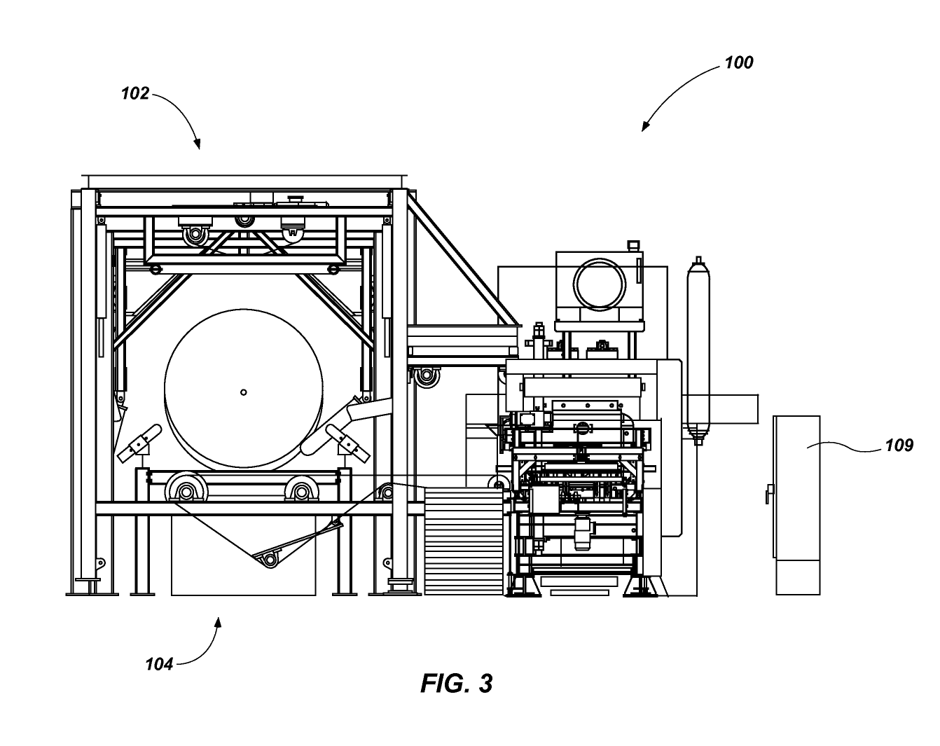

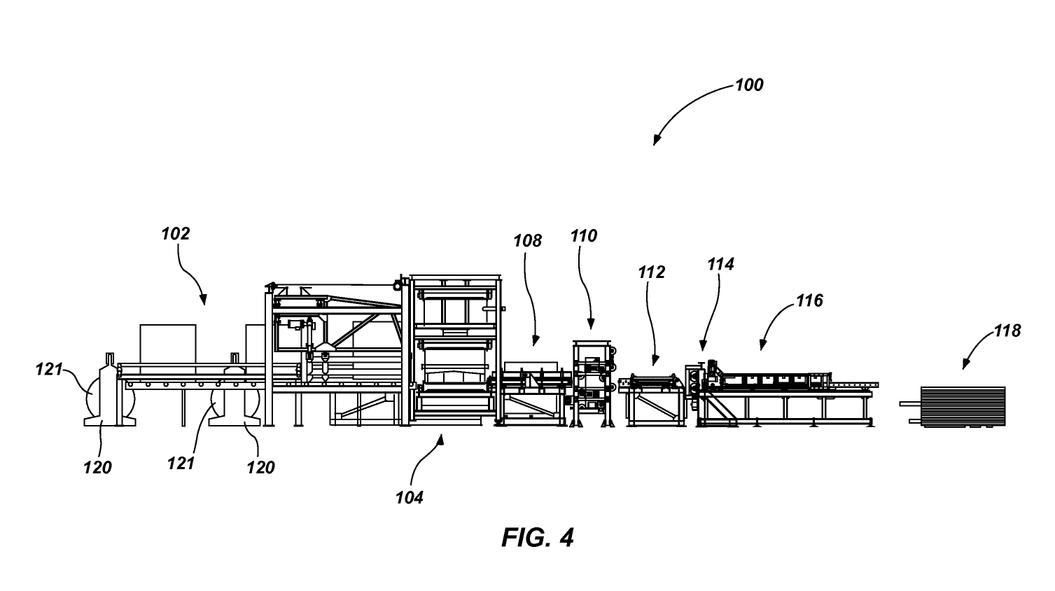

FIG. 3 is another view of system 100 taken along lines 3 of FIG. 1. Material receiving section 102 and feed section 104 are illustrated in FIG. 3. Further, an electrical box 109, which may comprise any electronics required for operation of system 100, is also illustrated in FIG. 3. FIG. 4 is yet another view of system 100 taken along lines 4 of FIG. 1.

During a contemplated operation, system 100 may be configured to receive a bale of material (e.g., a round bale of straw), unroll the bale of material, and compress the material to form a panel having a desirable thickness, length, and width. For example only, system 100 may be configured to form a panel having a thickness of substantially 2.5 inches and a width of substantially 32 inches, which is substantially equal to a distance between studs in standard building construction. Further, system 100 may include a controller 105 (see FIG. 2) for controlling various components of system 100 to enable for formation of a fiber panel having a desired length and a desired density, as will be described more fully below.

With specific reference to FIGS. 1 and 5-8, material receiving section 102, according to an exemplary embodiment of the present invention, will now be described. Material receiving section 102 includes a conveyor 202 for receiving a bale of material 204. As an example, bale of material 204 may comprise wheat straw, barley straw, rice straw, or any combination thereof. By way of example only, bale of material 204 may comprise a cylindrical-shaped bale of straw (i.e., a “round” bale), as specifically illustrated in FIGS. 1, 3, 5, and 7. Further, bale of material 204 may comprise, for example only, a round bale of straw having a width of substantially 62 inches and a diameter of substantially 72 inches. By way of example only, bale of material 204 may be baled by a John Deere 582 baler. Further, it is noted that material receiving section 102 may be configured to receive a bale of material that is unmodified after being “baled” in a field.

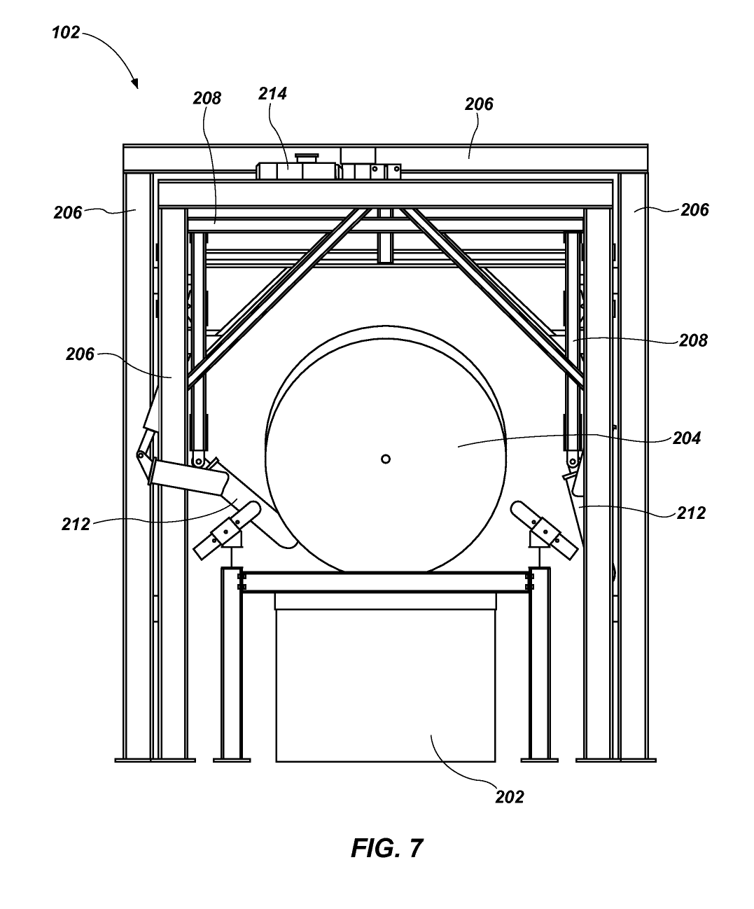

Material receiving section 102 may include a first structure 206, which has a fixed position, and a second structure 208, which may move relative to first structure 206 (i.e., in the directions indicated by arrows 210 and 211). Second structure 208 may include a plurality of arms 212 for lifting a bale of material 204 off of conveyor 202 and positioning the bale of material 204 onto another conveyor of feed section 104 (see FIG. 1). It is noted that second structure 208 may include a first arm proximate one side of conveyor 202 and another arm proximate another side of conveyor 202 (see e.g., FIG. 7). After the plurality of arms 212 have lifted a bale of material 204 off of conveyor 202, second structure 208 may move in direction 210 and place the bale of material onto another conveyor of feed section 104 (i.e., the plurality of arms may release the bale of material 204 onto a conveyor of feed section 104). After positioning the bale of material 204 onto the conveyor of feed section 104, second structure 208 may move in direction 211 to position itself to lift the next bale of material 204.

Material receiving section 102 may include a motor 214 for moving second structure 208 in either direction 210 or 211. Further, material receiving section 102 may include another motor 216 for powering the plurality of arms 212. It is noted that motor 214 and motor 215 may comprise hydraulic motors.

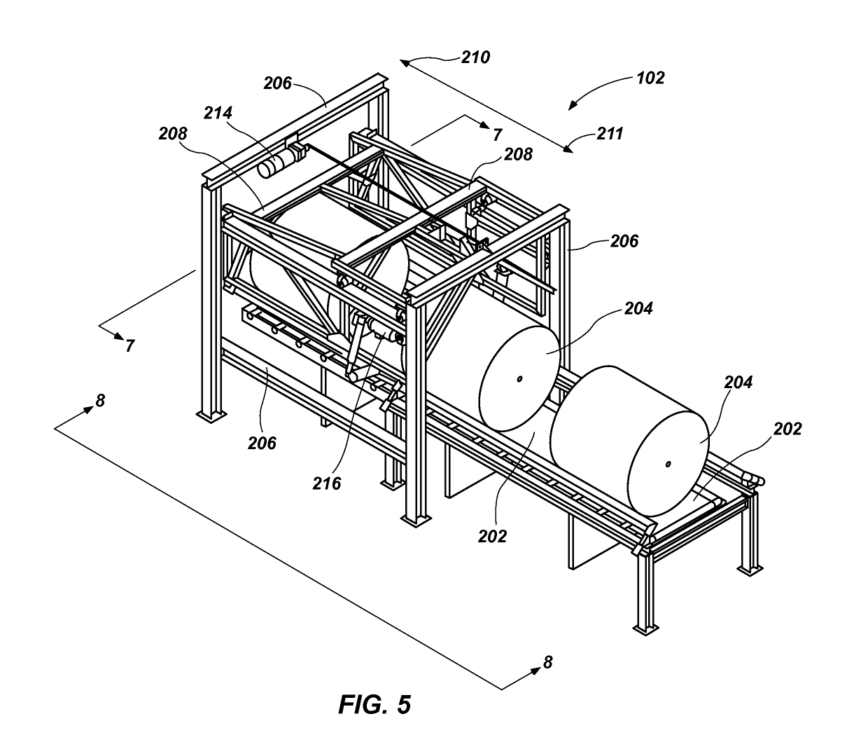

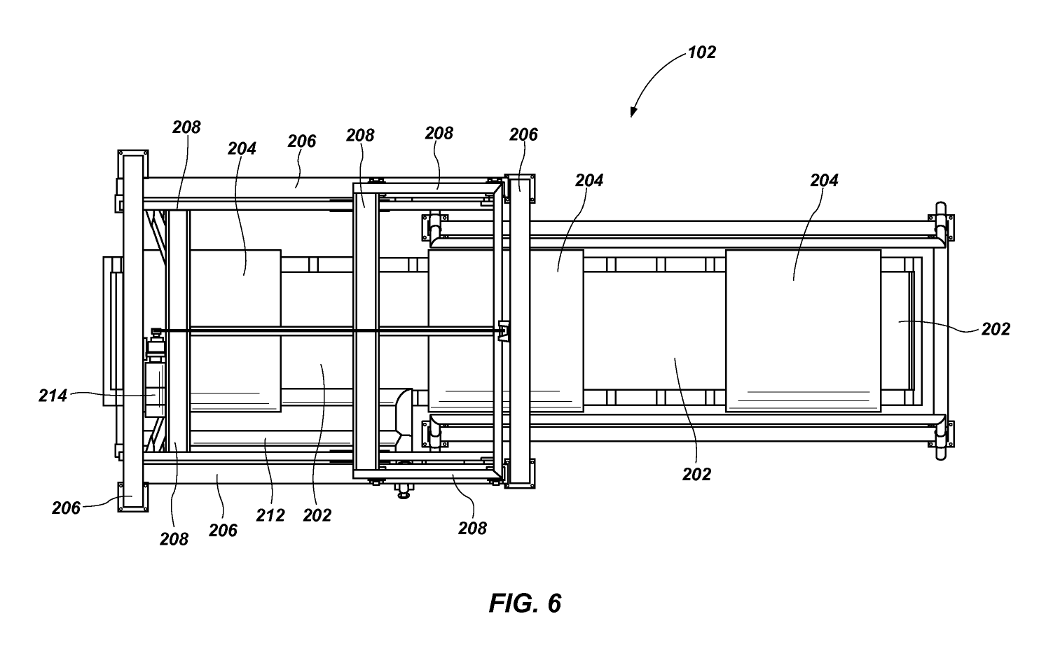

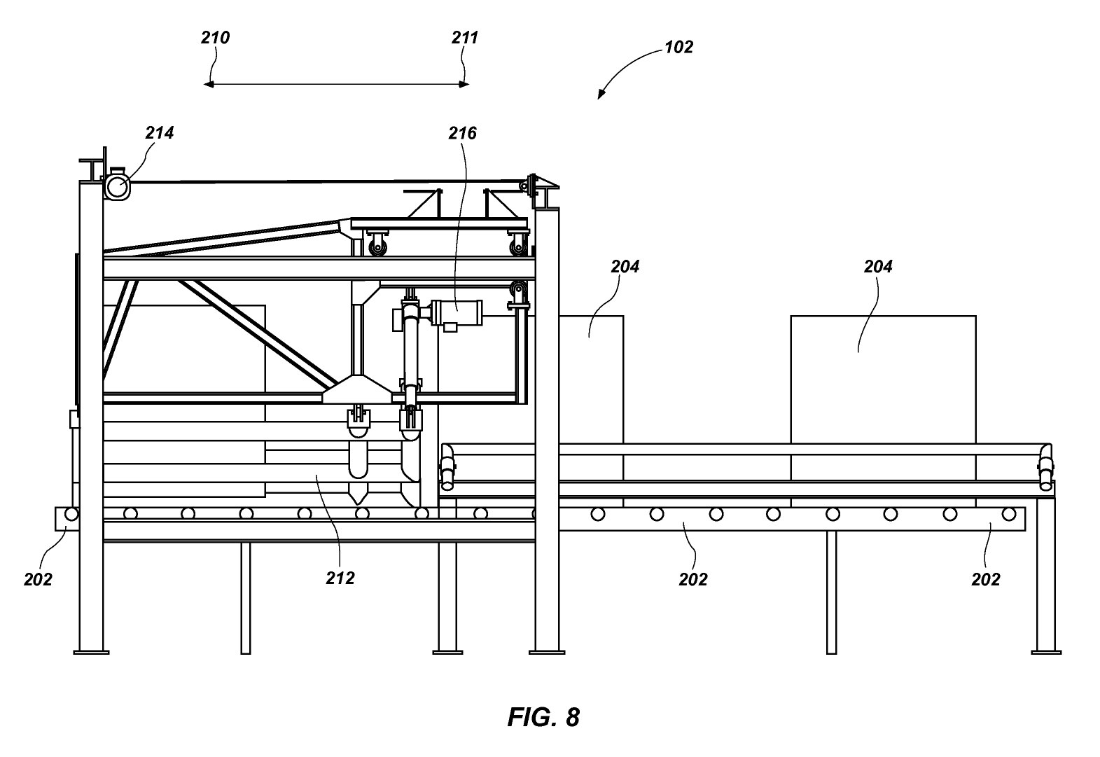

FIG. 6 is a top-down view of the material receiving section 102. Further, FIG. 7 is a view of material receiving section 102 taken along line 7 of FIG. 5. Moreover, FIG. 8 is a view of material receiving section 102 taken along line 8 of FIG. 5.

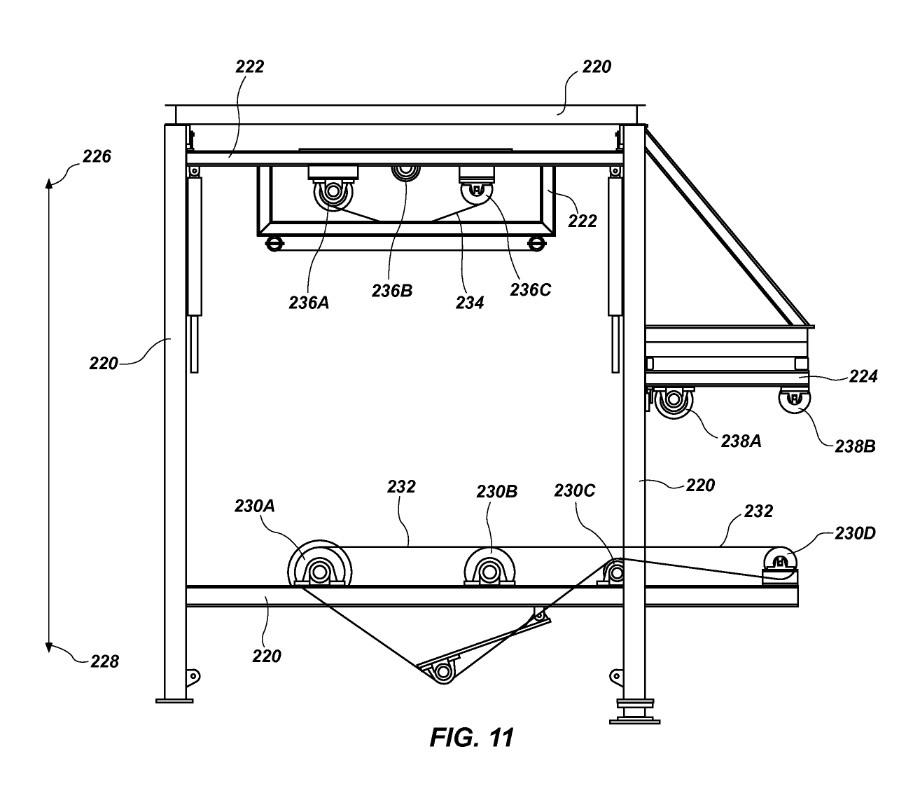

Feed section 104 will now be described with reference to FIGS. 1 and 9-12. Feed section 104 includes a first structure 220 having a fixed position. First structure 220 includes a plurality of rollers 230A-230D and a lower conveyor 232 (see FIG. 11). Further, feed section 104 includes a second structure 222, which is configured to move relative to first structure 220 (i.e., in the directions indicated by arrows 226 and 228). Second structure 222 includes a plurality of rollers 236A-236D and an upper conveyor 234 (see FIG. 11). Second structure 222 is configured to move in the direction indicated by arrow 228 to enable upper conveyor 234 to contact a bale of material positioned on lower conveyor 232. Collectively, lower conveyor 232 and upper conveyor 234 are configured to unroll a bale of material 204. It is noted that the speed of lower conveyor 232 and upper conveyor 234 is controllable, via controller 105, for controlling a speed at which the bale of material is unrolled. The rate at which upper conveyor 234 and lower conveyor 232 unroll material may be controlled in a manner that further enables the material to be fed into compression section 106 at a substantially constant rate (e.g., thickness/time, volume/time, weight/time, etc.), or in such a way that a substantially constant density of material is always fed into the remainder of the system.

Additionally, feed section 104 includes a third structure 224 including a plurality of rollers 238A and 238B and configured to move relative to first structure 220 (i.e., in the directions indicated by arrows 226 and 228). Rollers 238A and 238B, along with lower conveyor 232, may stabilize the unrolled material for subsequent processing by compression section 106. It is noted that third structure 224 may include a conveyor driven by rollers 238A and 238B. It is further noted that some rollers of feed section 104 may comprise passive rollers and other rollers may comprise active rollers (e.g., rollers driven by a motor).

Accordingly to one exemplary embodiment, feed section 104 may be physically isolated from other sections (e.g., compression section 106) of system 100. Further, feed section 104, which may include a scale (e.g., feed section 104 may be positioned on a plurality of load cells), may be configured to weigh each bale of material 204, and determine the weight of material that has been fed into the remainder of system (i.e., the material that has been fed into compression section 106). More specifically, as material is rolled from a bale, the change (i.e., decrease) in the amount of weight of the bale may be determined. Alternatively, the weight of the material taken from a bale may be directly determined. As will be described more fully below, the weight of the material fed into compressed section 106 (i.e., the weight of compressed material) may be used to determine a density of the compressed material. Further, feed section 104 may include one or more sensors (e.g., a light sensor) for determining if a material from a bale of material is positioned on lower conveyor 232.

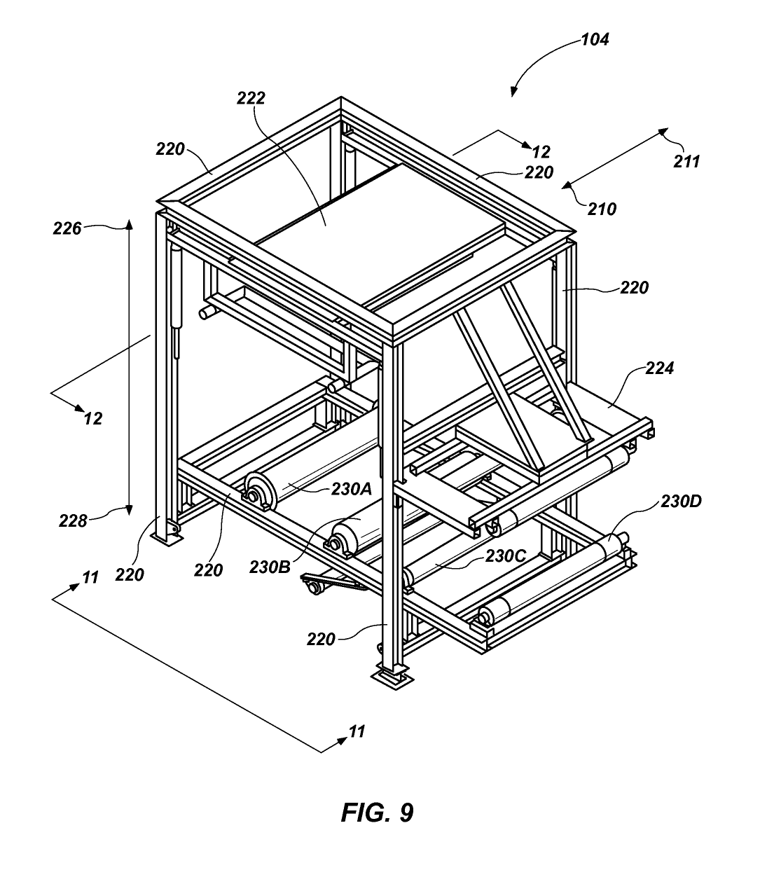

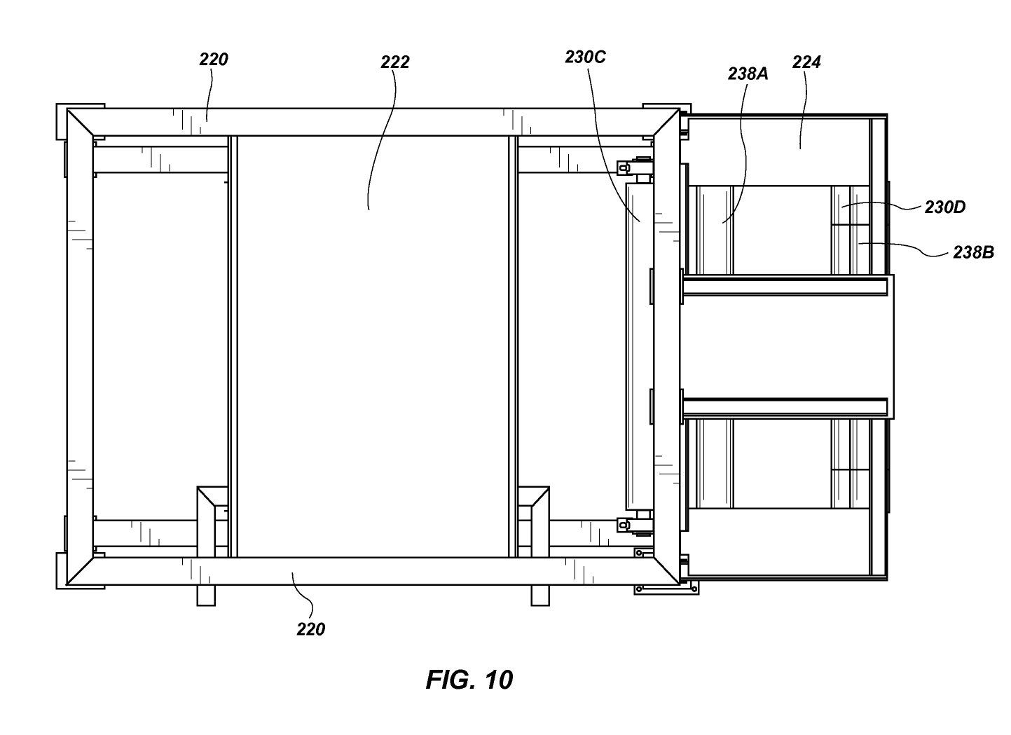

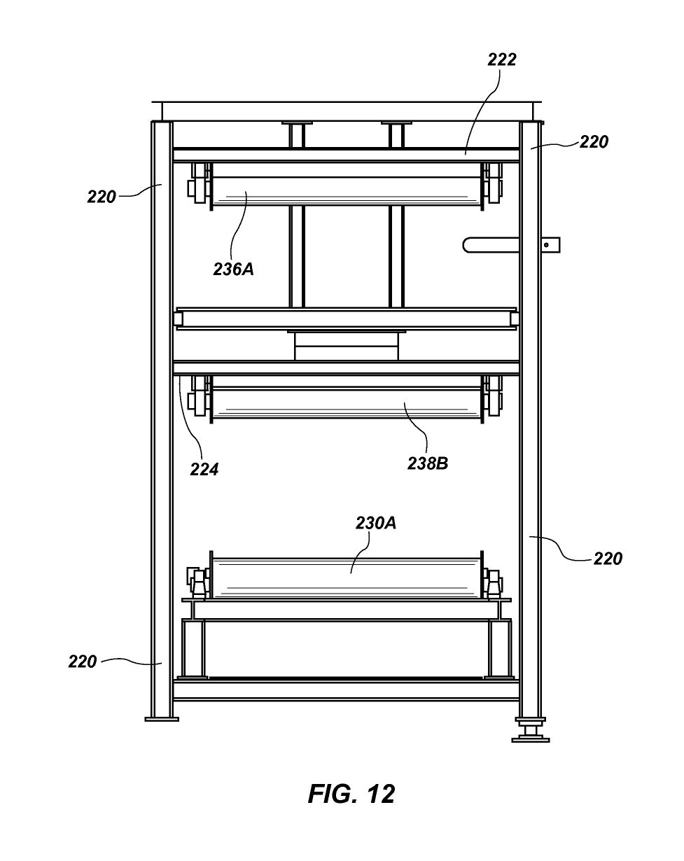

FIG. 10 is a top-down view of feed section 104. FIG. 11 is a view of feed section 104 taken along line 11 of FIG. 9. Further, FIG. 12 is a view of feed section 104 taken along line 12 of FIG. 9.

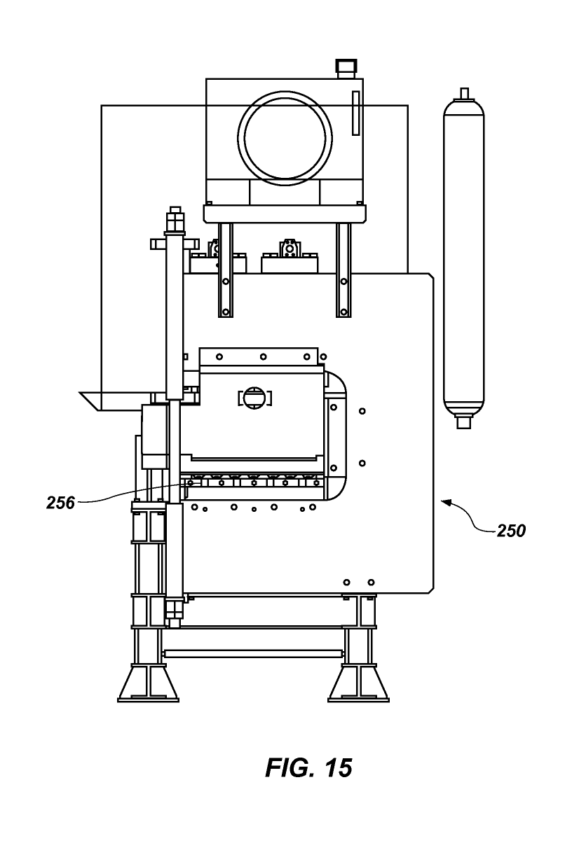

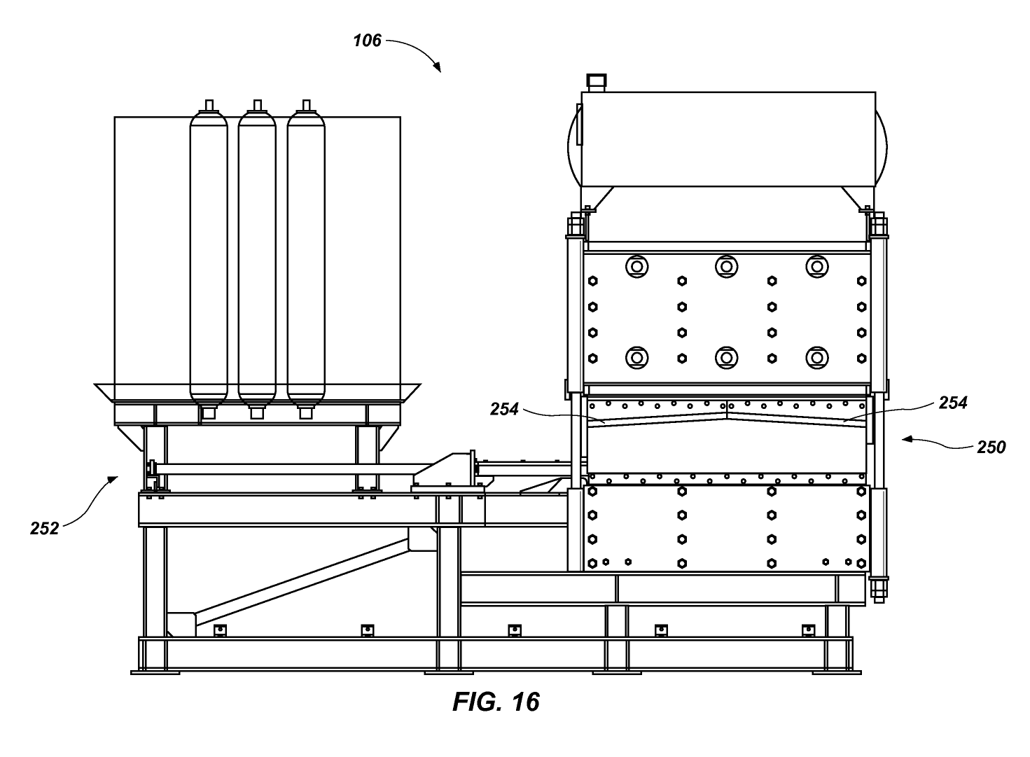

With reference now to FIGS. 1 and 13-16, compression section 106 will now be described. Compression section 106 may include a two-stage hydraulic compression system. More specifically, compression section 106 may include a hydraulic press 250 that is configured to cut material that has been unrolled from a bale, and apply a compressive force to the cut material. More specifically, press 250 may include a blade 254 (see FIG. 16) for cutting the material and a plate 256 (see FIG. 15) for applying the compressive force to the cut material. As an example, hydraulic press 250 may be configured to apply substantially one million pounds of compressive force to the unrolled material. Further, compression section 106 includes a plurality of pistons 252 configured to apply force to the material in a direction that is substantially perpendicular to the force applied by hydraulic press 250. Stated another way, hydraulic press 250 is configured to apply a force to the material in a direction illustrated by arrow 256 and pistons 252 are configured to apply a force to the material in a direction illustrated by arrow 258. By way of example only, the plurality of pistons 252 may comprise seven (7) pistons. As an example, pistons 252 are configured to apply forty thousand pounds of pressure per square inch to the material. It is noted that hydraulic press 250 and pistons 252 may be powered by a hydraulic motor.

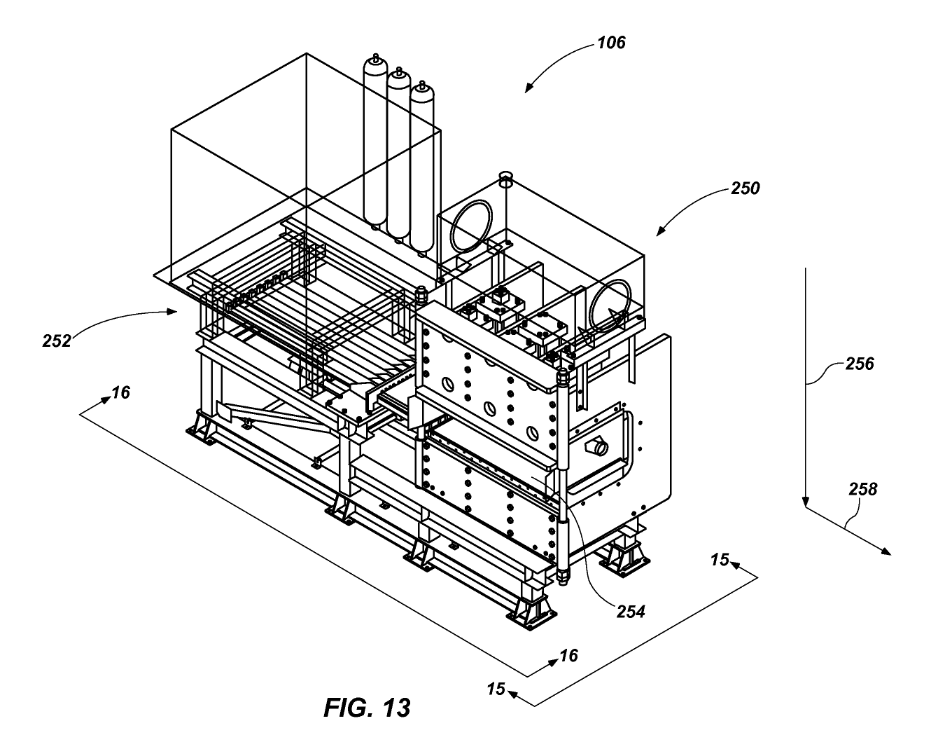

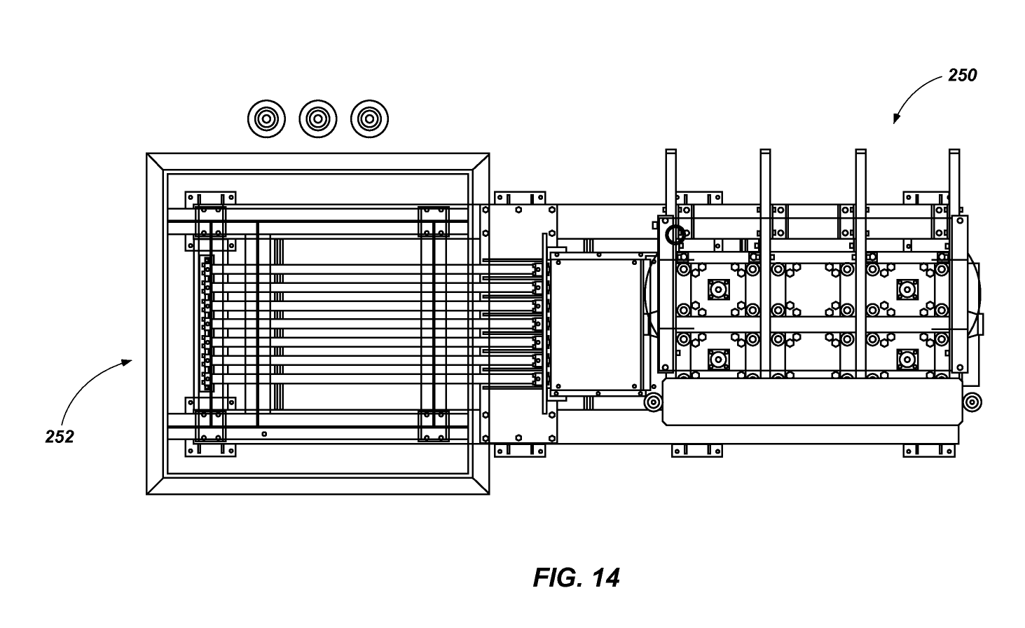

FIG. 14 is a top-down view of compression section 106. FIG. 15 is a view of compression section 106 taken along line 15 of FIG. 13. FIG. 16 is a view of compression section 106 taken along line 16 of FIG. 13.

Primary platens 108 will now be described with reference to FIGS. 1 and 17-20. Primary platen includes a bottom platen 280 and a top platen 282. Further, primary platen 108 includes a plurality of electrical heating elements (not shown), which may be positioned within grooves 284 formed in and extending the width of bottom platen 280 and top platen 282. For example, each heating elements may comprise a tubular heating element, such as a “calrod.” As will be appreciated by a person having ordinary skill, the heating elements may provide heat to the compressed material passing therethrough. Each heating element may include an electrical connection for receiving electricity. It is noted that each heating element may be independently controllable. Stated another way, controller 105 (see FIG. 2) may be configured to individually and independently control a temperature of each heating element of the plurality of heating elements. As a result, a temperature profile of primary platen 108 may be controllable. It is further noted that a temperature of primary platen may be varied depending on a type of material (e.g., rice straw, wheat straw, or barley straw) passing therethrough.

As will be appreciated by a person having ordinary skill, primary platen 108 may compact fiber material to form a dense panel and a width and a thickness of the panel may determined by dimensions of primary platen 108. Primary platen 108 may include a cover frame 286 positioned over top platen 282 and having an adequate weight to ensure top platen 280 remains in contact with bottom platen 282 while fiber material is passing therethrough.

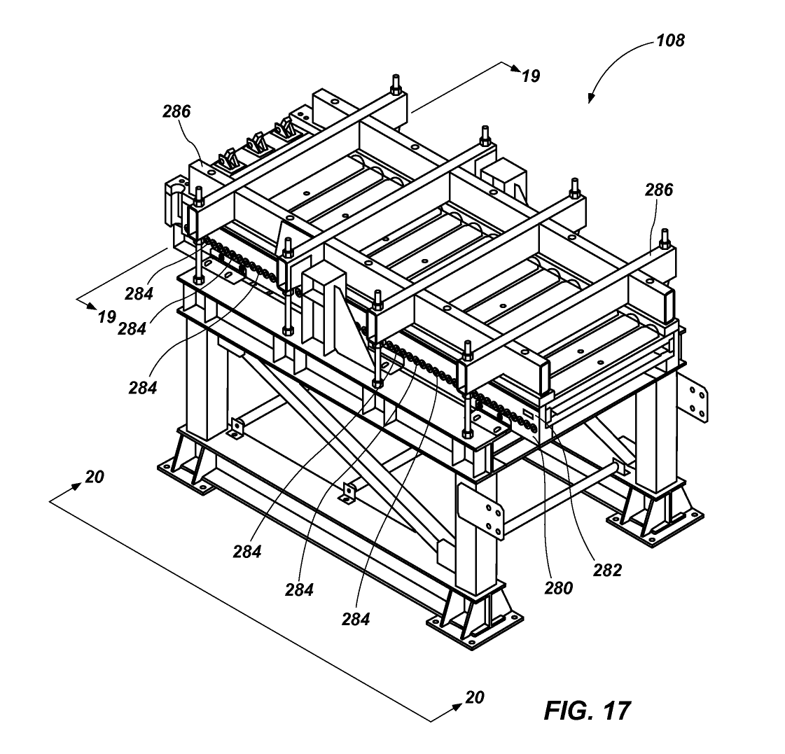

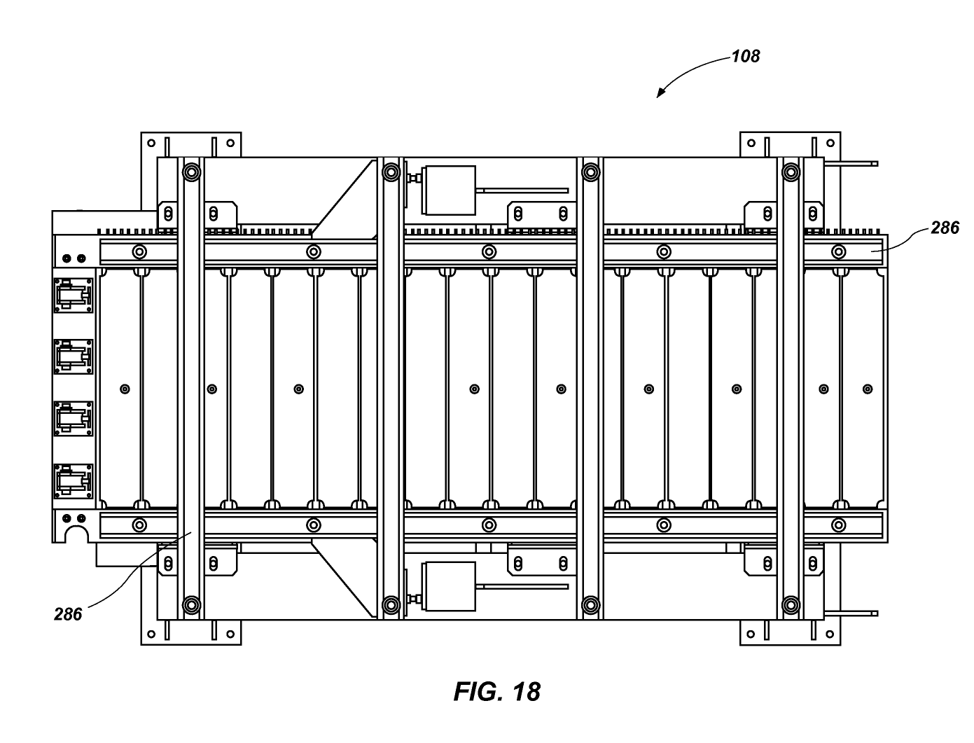

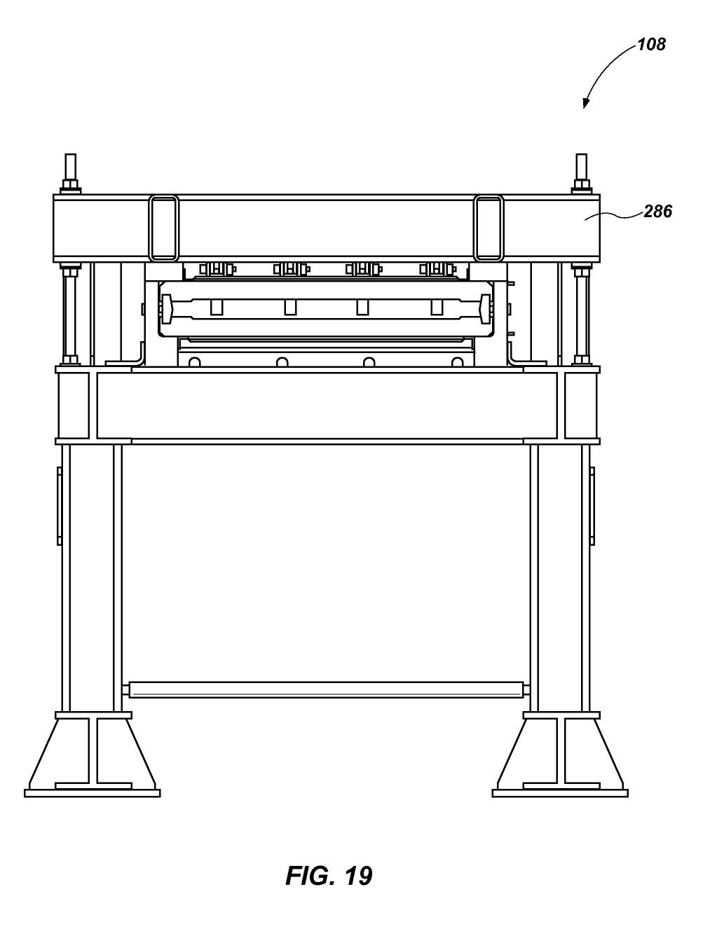

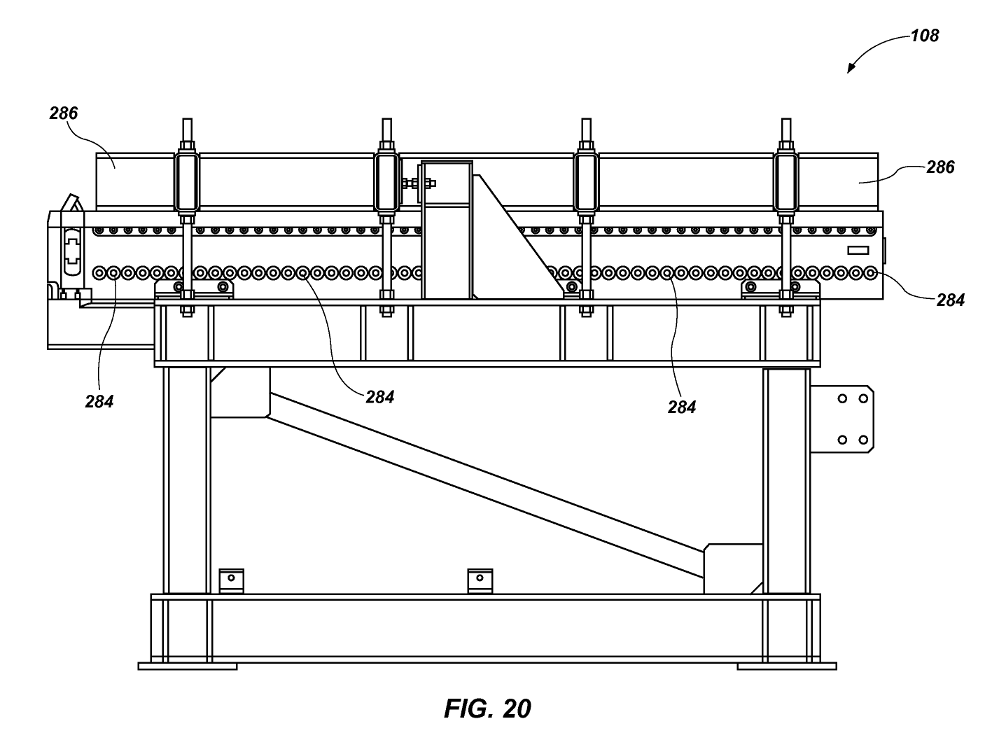

FIG. 18 is a top-down view of primary platen 108. FIG. 19 is a view of primary platen 108 taken along line 19 of FIG. 17. Moreover, FIG. 20 is a view of primary platen 108 taken along line 20 of FIG. 17.

Further, with reference now to FIGS. 1 and 21-24, adhesive applicator 110, secondary platens 112, and tension roller 114 will now be described. Adhesive applicator 110 is configured to apply an adhesive to one side of a piece of paper (i.e., paper from paper rolls 121) and, thereafter, apply the paper to compressed material. It is noted that adhesive applicator 110 may include mirroring application elements to simultaneously apply adhesive to one side of a first piece of paper and one side of a second piece of paper. For example only, an environmentally friendly, water based adhesive may be used.

Adhesive applicator 110 includes a first plurality of rollers 300 for contacting an upper piece of paper and a second plurality of rollers 302 for contacting a lower piece of paper. Further, adhesive applicator 110 includes a first glue roller pair 306 for applying adhesive to the upper piece of paper and a second glue roller pair 308 for applying adhesive to the lower piece of paper. It is noted that first glue roller pair 306 and second glue roller pair 308 may be controlled by controller 105 and, therefore, an amount of adhesive applied to the upper piece of paper and the lower piece of paper may be controllable. After an adhesive has been applied to the upper piece of paper and the lower piece of paper, the upper piece of paper (i.e., the side with the adhesive) may be applied to a side of the compressed material and the lower piece of paper (i.e., the side with the adhesive) may be applied to another, opposite side of the compressed material.

Secondary platens 112 include a bottom platen 322 and a top platen 320. Further, secondary platen 112 includes a plurality of electrical heating elements (not shown), which may be positioned within grooves 324 formed in and extending the width of bottom platen 322 and top platen 320. For example, each heating elements may comprise a tubular heating element, such as a “calrod.” As will be appreciated by a person having ordinary skill, the heating elements may provide heat to the fiber panel passing therethrough. Each heating element may include an electrical connection for receiving electricity. It is noted that each heating element may be independently controllable. Stated another way, controller 105 may be configured to individually and independently control a temperature of each heating element of the plurality of heating elements. As a result, a temperature profile of secondary platens 112 may be controllable. It is further noted that a temperature of secondary platens 112 may be varied depending on a type of material (e.g., rice straw, wheat straw, or barley straw) passing therethrough. Heat produced from the heating elements may assist in curing the adhesive applied to the top and bottom surfaces of the compressed fiber and to remove and/or reduce the “springback” inherent in the compressed fiber thereby contributing to a more stable panel member.

Tension rollers 114 may include one or more rollers 330 wherein each roller has a brake 332 associated therewith. More specifically, a brake 332A may control a speed of rotation of roller 330A and a brake 332B may control a speed of rotation of roller 330B. Stated another way, brake 332A may increase an amount of friction on roller 330A to decrease the rotational speed of roller 330A. Similarly, brake 332B may increase an amount of friction on roller 330B to decrease the rotational speed of roller 330B. On the other hand, brake 332A may decrease an amount of friction on roller 330A to increase the rotational speed of roller 330A. Similarly, brake 332B may decrease an amount of friction on roller 330B to increase the rotational speed of roller 330B. It is noted that brakes 332 may be controlled via controller 105. It is further noted that increasing the rotational speed of rollers 330A and 330B may increase the speed at which compressed material is conveyed through system 100. Further, decreasing the rotational speed of rollers 330A and 330B may decrease the speed at which compressed material is conveyed through system 100. Thus, a density of compressed material may be modified by adjusting tension rollers 114.

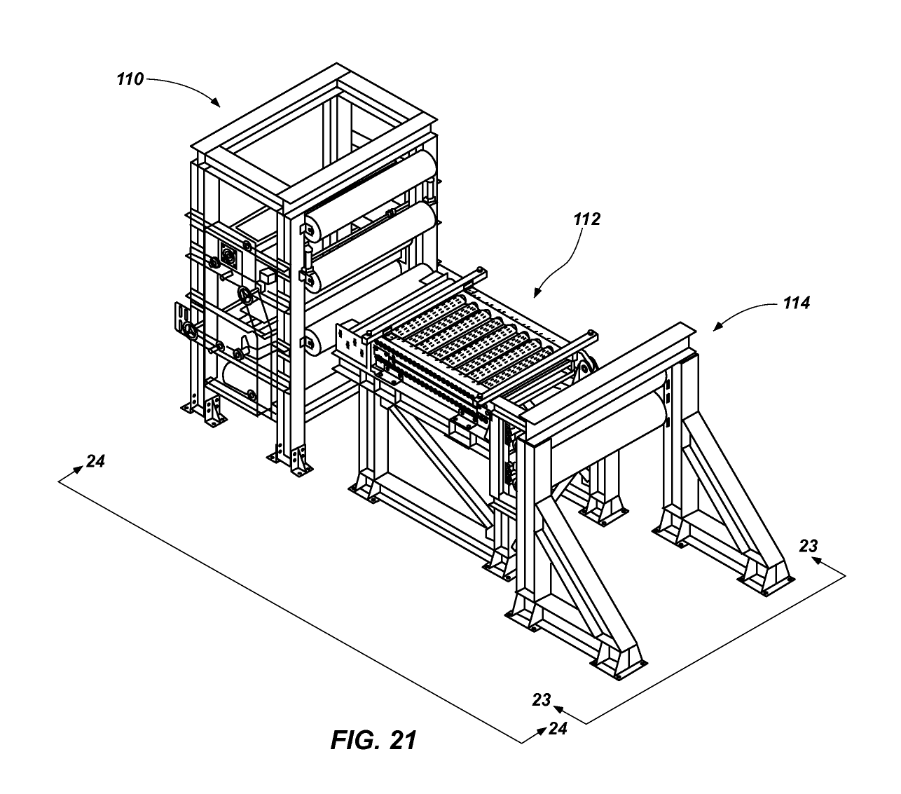

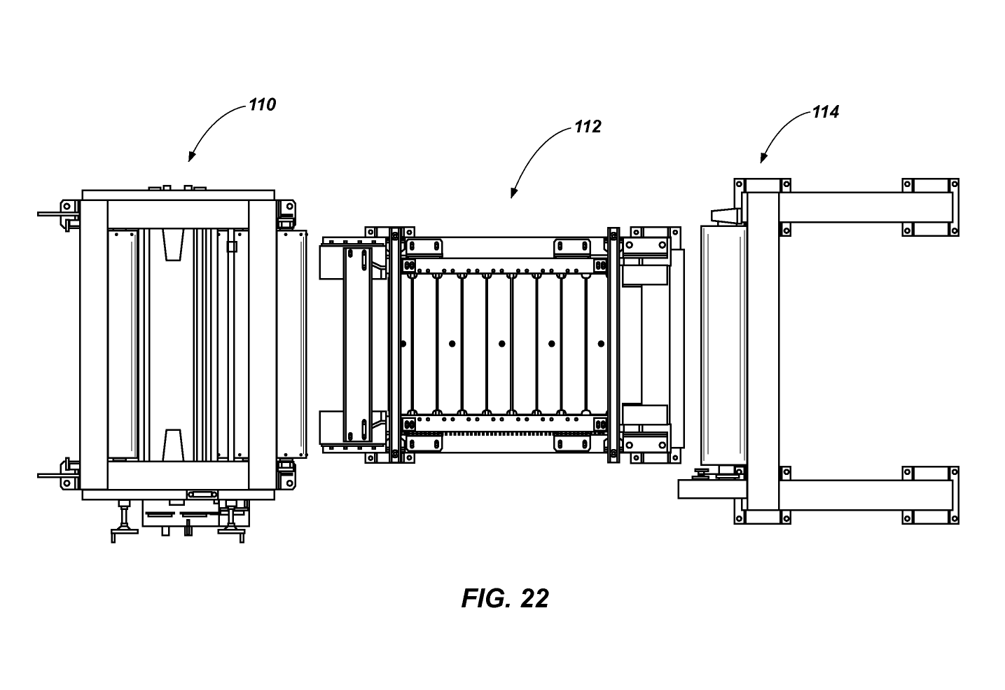

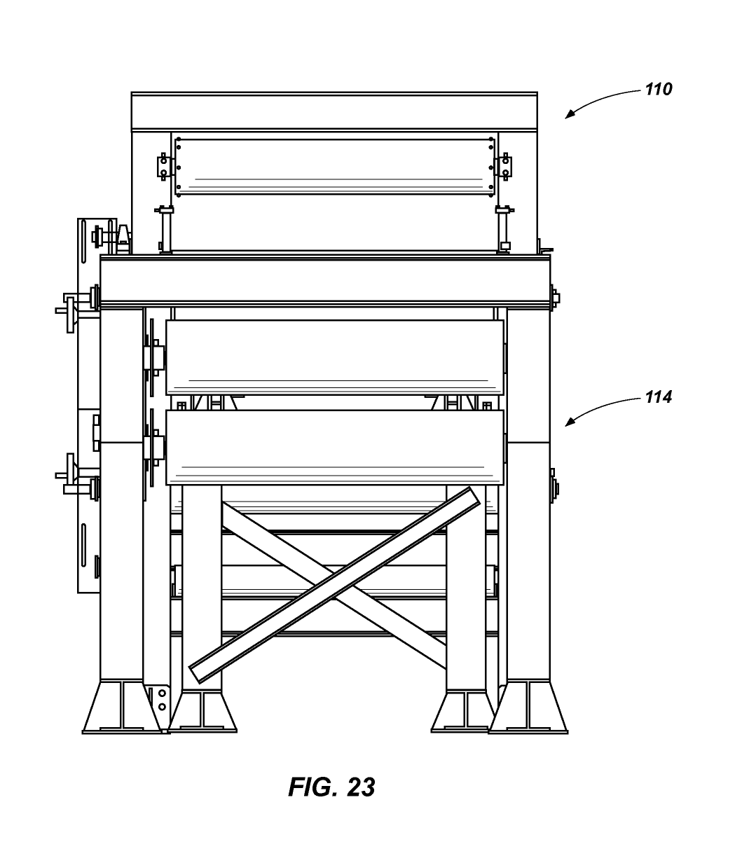

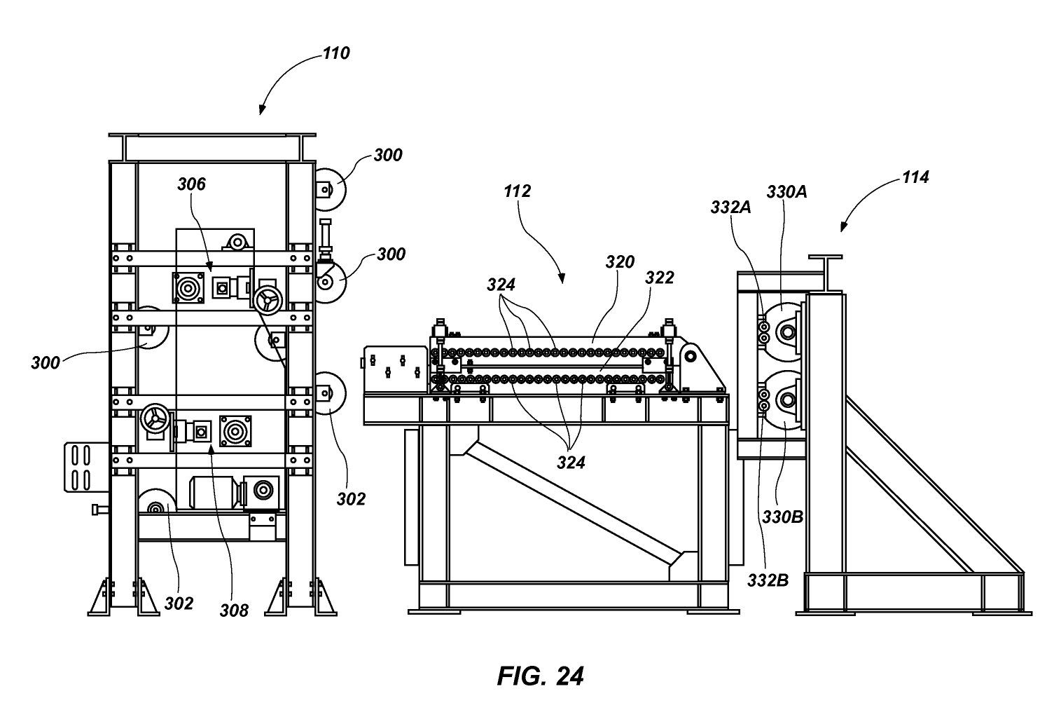

FIG. 22 is a top-down view of adhesive applicator 110, secondary platens 112, and tension roller 114. FIG. 23 is a view of adhesive applicator 110, secondary platens 112, and tension roller 114 taken along line 23 of FIG. 21. FIG. 24 is a view of adhesive applicator 110, secondary platens 112, and tension roller 114 taken along line 24 of FIG. 21.

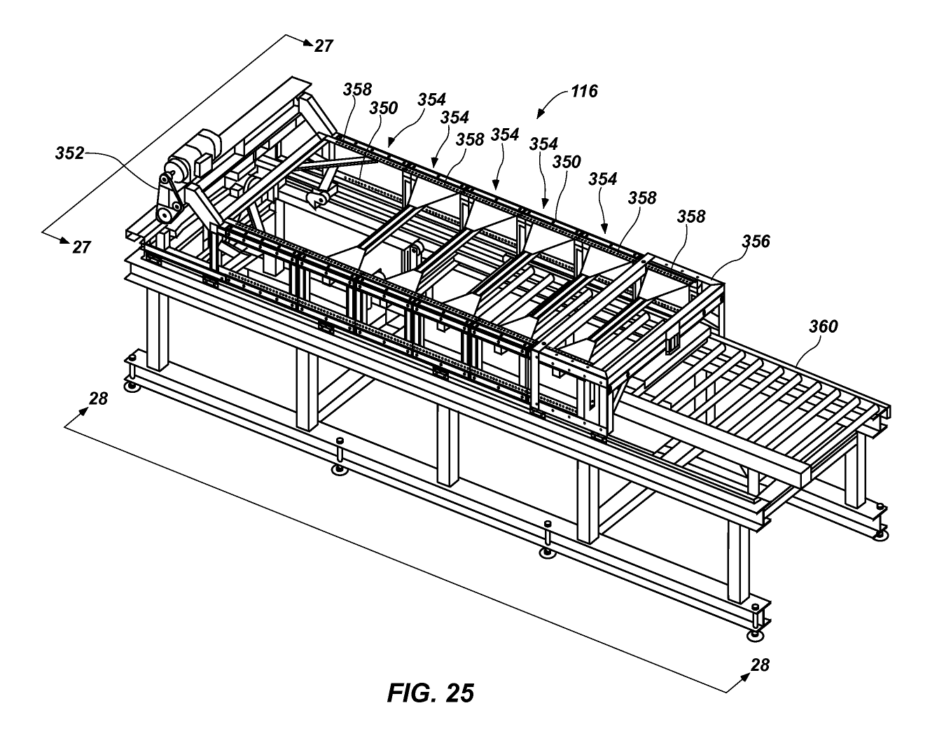

FIGS. 25-28 illustrate a cutting section 116, according to an exemplary embodiment of the present invention. Cutting section 116 may comprise a receiving structure 350, which includes a plurality of removable portions 354, and a receiving rail 360. A length of receiving structure 350 may be adjusted by either removing or adding one or more removable portions 354. Cutting section 116 further includes a stop or a sensor 356, which may be configured to stop the compressed material relative to receiving structure 350. Further, cutting section 116 includes a saw 352, which may comprise a “flying cut-off saw,” configured to cut compressed material as the compressed material passes into cutting section 116. It is noted that when the compressed material is sensed by sensor 356 (e.g., as the compressed material reaches sensor 356), saw 352 may cut the compressed material and the receiving section 350, along with the resulting fiber panel (i.e., the cut compressed material), may continue to move relative to receiving rail 360. Accordingly, a length of a resulting fiber panel may be adjusted by adjusting a position of sensor 356 relative to saw 352. For example, a removable portion 354 may be removed to decrease a length of receiving section 350 and, thus, enable sensor 356 to be closer to saw 356. Therefore, a length of a resulting fiber panel may be decreased. Further, each portion 354 includes a plurality of holes 358, which are spaced, for example, one inch apart. Therefore, according to one example, sensor 356 may be moved relative to saw 352 by coupling sensor 356 to a differed hole 358. Accordingly, cutting section 116 may be configured for adjusting a length of a resulting fiber panel by, for example, one inch increments.

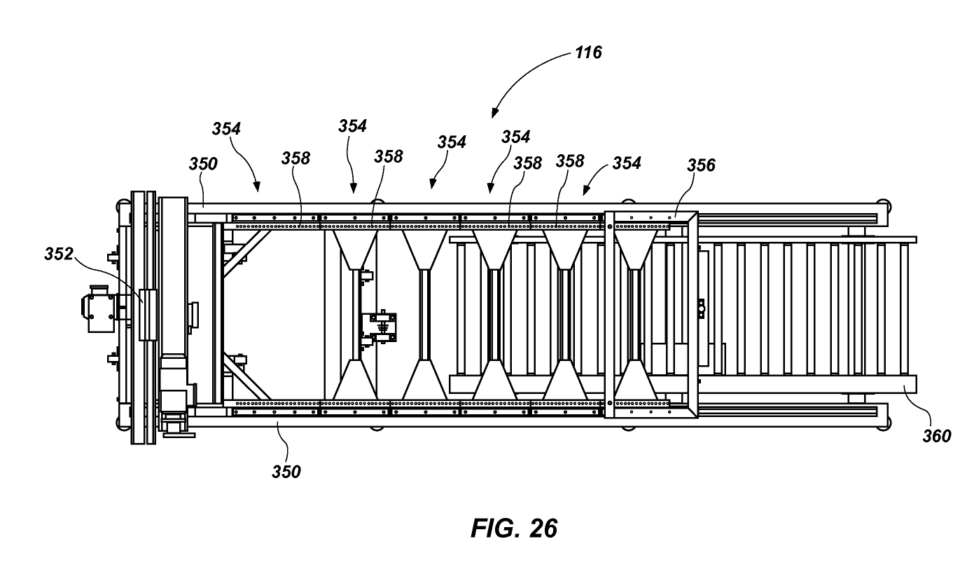

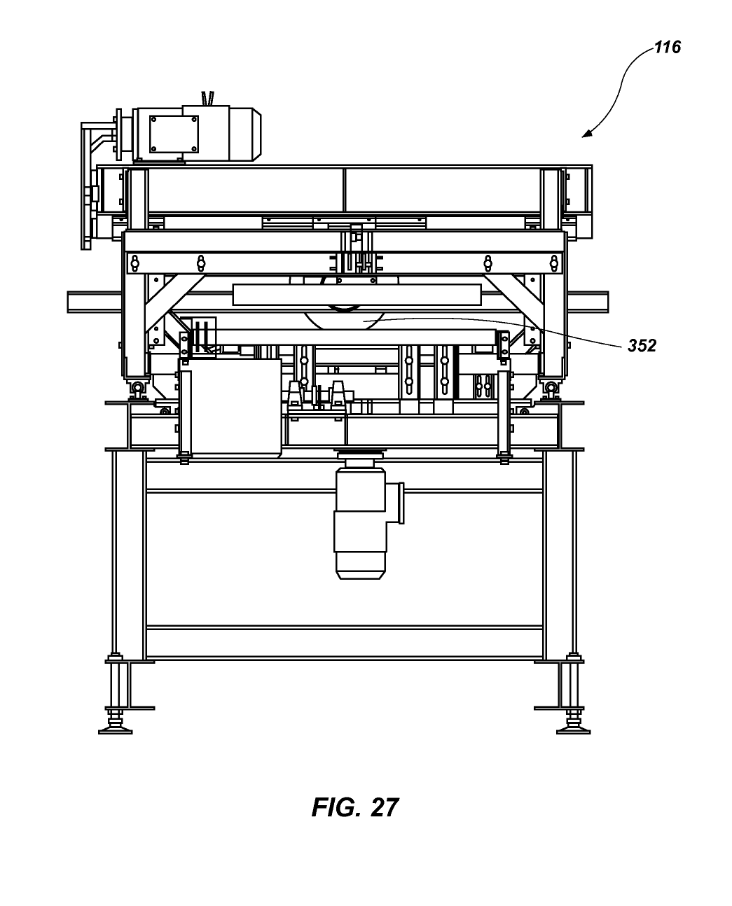

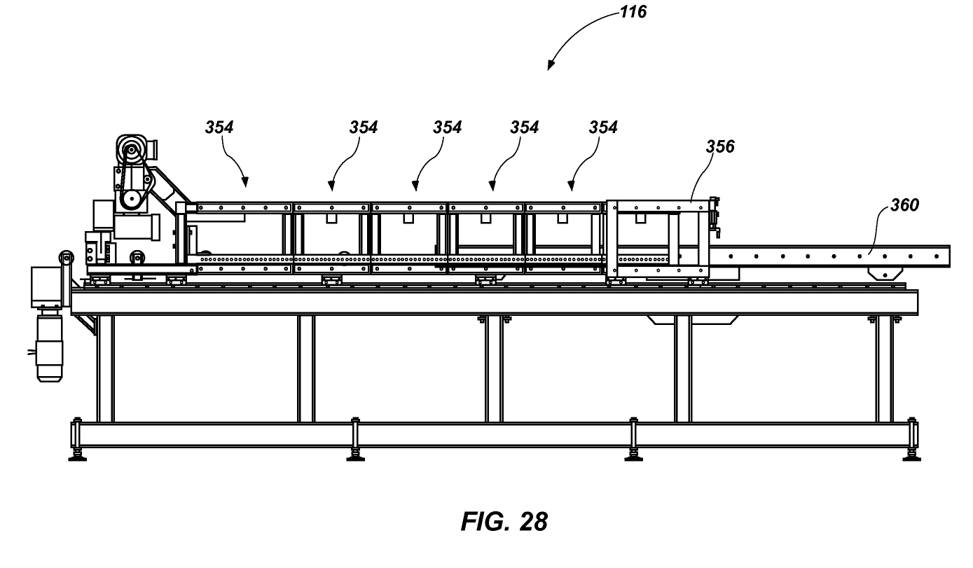

FIG. 26 is a top-down view of the cutting section 116. FIG. 27 is a view of cutting section 116 taken along line 27 of FIG. 25. FIG. 28 is a view of cutting section 116 taken along line 28 of FIG. 25. It is noted that compression section 106, primary platens 108, adhesive applicator 110, secondary platens 112, tension roller 114, and cutting section 116 may collectively be referred to as a “curing section.”

As noted above, a weight of compressed material within the curing section of system 100 may be determined. Further, because a width and a thickness of the compressed material are known, at any specific position along the curing section, a volume of the compressed material may be determined. Therefore, a density of the compressed material may be calculated. Additionally, by adjusting a rate at which the material is fed into compression section 106, by adjusting tension roller 114, or both, a density of the compressed material may be adjusted.

With reference again to FIG. 1, controller 105 may be configured to receive status signals from various sensors on system 100. For example only, status signals may be used by controller 105, an operator of system 100, or both, for making adjustments to one more sections of system 100. Further, controller 105 may be configured to periodically measure a density of compressed material in system 100. In addition, controller 105 may be configured to convey one or more control signals to one or more sections of system 100 for controlling operation thereof. For example, controller 105 may be configured for controlling the timing of devices within system relative to each other. As another example, controller 105 may be configured to control a speed of one or more rollers of system 100, control brakes 332A and 332B of tension roller 114, or both. Further, controller 105 may be configured to control each heating element of primary platens 108 and secondary platens 112. As another example, controller 105 may be configured to control an amount of adhesive applied to each piece of paper at adhesive applicator 110. Accordingly, system 100 may comprise a closed loop control system configured to gather data (i.e., feedback) and make operational adjustments to one or more sections in response to the gathered data.

It is noted that the operation of material receiving section 102, feed section 104, and compression section 106 may be powered by, for example, hydraulic systems. Further, primary platens 108, adhesive applicator 110, secondary platens 112, tension roller 114, and cutting section 116 may be powered by pneumatic systems. The various components (i.e., sections) of system 100 may be disassembled from one another for shipping and then reassembled at their desired destination. Moreover, it is noted that each section of system may be configured to be movable by a forklift. Further, fiber panels formed by system may be used in, for example only, modular housing and other buildings (e.g., by Newcon, Newcor Steel, etc.).

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A system, comprising:
a feed section for unrolling a round bale of material;
a compression section for receiving material from the unrolled bale of material and comprising a press configured to cut and apply a force to the material and a plurality of pistons to apply another force to the material; and
an adjustable cutting section including a saw and configured to cut the compressed material to form a panel having a desired length.

2. The system of claim 1, further comprising a receiving section including a conveyor and a plurality of arms for moving the round bale of material from the conveyor to the feed section.

3. The system of claim 1, further comprising an adhesive applicator for substantially simultaneously gluing a first piece of paper to a first side of the compressed material and a second piece of paper to a second, opposite side of the compressed material.

4. The system of claim 1, further comprising a tension roller positioned between the compression section and the cutting section and for adjusting a rate at which the material is conveyed through the compression section.

5. A system, comprising:
a feed section for unrolling a cylindrical bale of material;
a two-stage compression section configured to cut and apply a compression force to material of the unrolled bale of material in at least two directions to form compressed material; and
a controller configured for adjusting at least the feed section to control a density of the compressed material.

6. The device of claim 5, the controller further configured to adjust a speed of at least one conveyor of the feed section.

7. The device of claim 5, further comprising a tension roller, the controller further configured to adjust a tension of the tension roller to further control the density of the compressed material.

8. A method, comprising:
unrolling a round bale of material;
applying a compression force to material of the unrolled bale of material;
applying another, different compression force to the material; and
cutting the compressed material to form a panel having a desired length.

9. The method of claim 8, the unrolling comprising unrolling the round bale of material with a plurality of conveyors.

10. The method of claim 8, further comprising conveying the unrolled material to a compression stage at a substantially constant rate.

11. A method, comprising:
unrolling a cylindrical bale of material;
cutting and applying a compression force to material of the unrolled bale of material in at least two directions; and
generating a panel from the compressed material having a desired density.

12. The method of claim 11, further comprising measuring a density of the compressed material.

13. A device, comprising:
a first conveyor for receiving a round bale of material; and
a second conveyor vertically spaced from the first conveyor and configured to contact the bale of material, the first conveyor and the second conveyor configured to unroll the bale of material at a desired rate.

14. The device of claim 13, the second conveyor being movable in a vertical direction relative to the first conveyor.

15. The device of claim 13, further comprising at least one roller configured to drive the first conveyor.

16. The device of claim 13, further comprising at least one roller configured to drive the second conveyor.

17. The device of claim 13, further comprising a third conveyor laterally spaced from the second conveyor and configured to support unrolled material from the bale of material for subsequent processing.

18. The device of claim 17, the third conveyor being movable in a vertical direction relative to the first conveyor

19. The device of claim 13, the bale of material comprising a bale of straw.

20. The device of claim 13, further configured to weigh the bale of material.

21. The device of claim 13, further comprising at least one sensor for determining if material from the bale of material is positioned on the first conveyor.

22. The device of claim 13, further comprising a plurality of load cells for weighing a bail of material positioned on the first conveyor.

23. A device, comprising:
a first plurality of rollers configured to contact a first piece of paper;
a first glue roller pair configured to apply adhesive to one side of the first piece of paper;
a second plurality of rollers configured to contact a second piece of paper; and
a second glue roller pair configured to apply adhesive to one side of the second piece of paper;
the device configured to apply the one side of the first piece of paper to a first side of compressed material and apply the one side of the second piece of paper to a second, opposite side of the compressed material.

24. The device of claim 23, the first glue roller pair and the second glue roller pair configured to apply the adhesive to a respective piece of paper substantially simultaneously.

25. The device of claim 23, the adhesive comprising a water-based adhesive.

26. A device, comprising:
a blade to cut a piece of unrolled material from a round bale of material;
a plate to apply a compression force to the cut piece of material in a first direction;
a plurality of pistons to apply another compression force to the piece of material in a second, different direction.

27. The device of claim 26, the plurality of pistons comprising seven pistons.

28. The device of claim 26, the plate configured to apply a force of up to one million pounds of pressure to the cut piece of material in the first direction.

29. The device of claim 26, the plurality of pistons configured to apply a force of up to forty thousand pounds of pressure per square inch to the piece of material in the second, different direction.

30. The device of claim 26, the first direction substantially perpendicular to the second direction.

31. The device of claim 26, the blade, the plate, and the plurality of pistons powered by a hydraulic system.

32. A control system for forming a fiber panel having a desired density, the control system, comprising:
at least one conveyor for unrolling a round bale of material;
a compression section for applying at least one compression force to an unrolled piece of material;
at least one adjustable tension roller for adjusting a rate at which compressed material is conveyed through the compression section; and
a controller for adjusting at least one of the at least one conveyor and the at least one adjustable tension roller to control a density of the compressed material.

33. The device of claim 32, the at least one tension roller comprising at least one brake for adjusting a tension thereof.

34. The device of claim 33, the controller configured to adjust the at least one brake.

35. The device of claim 32, the controller configured to adjust a speed of the at least one conveyor.

36. The device of claim 32, further comprising at least one platen having a plurality of tubular heating elements.

37. The device of claim 36, the controller configured to individually control a temperature of each heating element of the plurality of heating elements.

38. A device, comprising:
a first paper roll;
a first festoon configured to receive unrolled paper from the first paper roll and configured to provide slack in the unrolled paper between the first paper roll and a subsequent stage for applying the unrolled paper to a first side of compressed material;
a second paper roll; and
a second festoon configured to receive unrolled paper from the second paper roll and configured to provide slack in the unrolled paper between the second paper roll and a subsequent stage for applying the unrolled paper to a second, opposite side of the compressed material.

39. The device of claim 38, each of the first festoon and the second festoon having at least one sensor for sensing an amount of slack between a respective paper roll and a respective subsequent stage.

40. A device, comprising:
a receiving structure having an adjustable length and for receiving compressed material having a width and a thickness; and
a saw coupled to the receiving structure and configured to cut the compressed material to form a fiber panel having a desired length.

41. The device of claim 40, the length of the receiving structure defining the desired length of the fiber panel.

42. The device of claim 40, the receiving structure including a plurality of removable portions for defining a length thereof.

43. The device of claim 40, the saw comprising a flying cut-off saw.

44. The device of claim 40, further comprising a sensor to enable for activation of the saw upon sensing the compressed material.

45. A computer-readable storage medium storing instructions that when executed by a processor cause the processor to perform instructions for forming a fiber panel, the instructions comprising:
unrolling a round bale of material;
applying a compression force to material of the unrolled bale of material;
applying another, different compression force to the material; and
cutting the compressed material to form a panel having a desired length.

46. A computer-readable storage medium storing instructions that when executed by a processor cause the processor to perform instructions for forming a fiber panel, the instructions comprising:
determining a density of compressed straw in a curing section of a fiber panel system; and
adjusting an operation of at least one section within the fiber panel system to adjust the density of the compressed straw.

47. A computer-readable storage medium storing instructions that when executed by a processor cause the processor to perform instructions for forming a fiber panel, the instructions comprising:
unrolling a round bale of straw;
applying at least one compression force to an unrolled piece of straw; and
adjusting at least one of a rate at which the round bale of straw is unrolled and a rate at which the compressed straw is conveyed to a cutting section to control a density of the compressed straw.

48. A method, comprising:
determining a density of compressed straw in a curing section of a fiber panel system; and
adjusting an operation of at least one section within the fiber panel system to adjust the density of the compressed straw.

49. The device of claim 48, the determining a density comprising determining a weight and volume of the compressed straw in the curing section of the fiber panel system.

50. The device of claim 48, the adjusting comprising adjusting at least one of a speed of at least one conveyor of the fiber panel system and a tension of a tension roller of the fiber panel system.
